(19) United States
(12) Patent Application Publication
(10) Pub. No.: US 2026/0222518 A1
(43) Pub. Date: Jul. 30, 2026

(54) METHOD OF MIXING AUDIO BEAMS FROM MICROPHONE ARRAY BASED ON HEAD DETECTION AND MEETING ZONE

(71) Applicant: Cisco Technology, Inc., San Jose, CA (US)

(72) Inventors: Asbjorn Therkelsen, Nesbru (NO); Sindre Meringdal, Nittedal (NO)

(21) Appl. No.: 19/038,864

(22) Filed: Jan. 28, 2025

(51) Int. Cl. H04N 7/14; G06T 7/20; G06V 40/16; H04N 7/15

(52) U.S. Cl. CPC H04N 7/147; G06T 7/20; G06V 40/161; H04N 7/15

(57) ABSTRACT

A method is performed by a controller of a conference device that includes a video camera and a microphone array deployed in a room. The method comprises: receiving video of the room from the video camera; receiving beam-specific audio of the room detected by respective ones of audio beams formed by the microphone array; processing the video to detect face positions of faces in the room; accessing information that pre-defines a region in the room independent from the video and the beam-specific audio; determining one or more first audio beams that each overlaps any face position in the region; and during a video conference session, transmitting, to a remote conference device, first beam-specific audio detected by the one or more first audio beams.

### TECHNICAL FIELD

The present disclosure relates to controlling audio beams of a conference device.

### BACKGROUND

A conference device may include internal and external microphone arrays that form many audio beams to capture audio from participants to a video conference session in a meeting room. The audio beams may cover an entirety of the room. During the video conference session, only a subset of the audio beams may actually have participants located within coverage areas of the audio beams. When the conference device mixes audio detected by all of the audio beams into mixed audio transmitted to a remote conference device, the mixed audio may include unnecessary and disturbing sounds. Such undesired sounds can include speech that reflects off a wall as reverberation, noise from a heating, ventilation, and air conditioning (HVAC) system, and noise from outside the meeting room, for example.

Additionally, audio mixing algorithms face challenges when attempting to select a preferred microphone signal, among multiple microphone signals, for inclusion in the mixed audio. There are multiple ways to determine the preferred microphone signal; however, acoustic reflections and other acoustic effects in the meeting room can trick the audio mixing algorithms into making wrong decisions. This can lead to suppressing desired audio from participants, for example, which results in an inferior meeting experience.

### BRIEF DESCRIPTION OF THE DRAWINGS

FIG. 1 is an illustration of a conference device that mixes audio detected by audio beams formed by one or more microphone arrays, based on face detection and tracking and a region-of-interest (ROI), according to an example embodiment.

FIG. 2 is a block diagram of a controller of the conference device, according to an example embodiment.

FIG. 3 shows audio signal flow between components of the conference device, according to an example embodiment.

FIG. 4 shows a top view of a conference arrangement of a room that is useful for describing operations performed by the conference device, according to an example embodiment.

FIG. 5 shows a two-dimensional (2D) projection of an area of the room covered by audio beams generated by a ceiling-mounted microphone array of the conference device, according to an example embodiment.

FIG. 6 shows a side view of the conference arrangement of the room corresponding to the top view of FIG. 4.

FIG. 7 shows a side view of another conference arrangement of the room for which the controller detects a face of an additional participant having a face that overlaps an audio beam, according to an example embodiment.

FIG. 8 shows another conference arrangement in which the controller performs face tracking to track movement of face positions over time, according to an example embodiment.

FIG. 9 is a flowchart of a method of mixing audio beams from a microphone array based on head detection and tracking and an ROI, according to an example embodiment.

FIG. 10 shows a geometry arrangement that may be used to determine whether a face position is in an audio beam and inside the ROI, according to an example embodiment.

FIG. 11 illustrates a hardware block diagram of a computing device that may perform functions presented herein, according to an example embodiment.

### DETAILED DESCRIPTION

### Overview

In an embodiment, a method is performed by a controller of a conference device that includes a video camera and a microphone array deployed in a room. The method comprises: receiving video of the room from the video camera; receiving beam-specific audio of the room detected by respective ones of audio beams formed by the microphone array; processing the video to detect face positions of faces in the room; accessing information that pre-defines a region in the room independent from the video and the beam-specific audio; determining one or more first audio beams that each overlaps any face position in the region; and during a video conference session, transmitting, to a remote conference device, first beam-specific audio detected by the one or more first audio beams.

### Example Embodiments

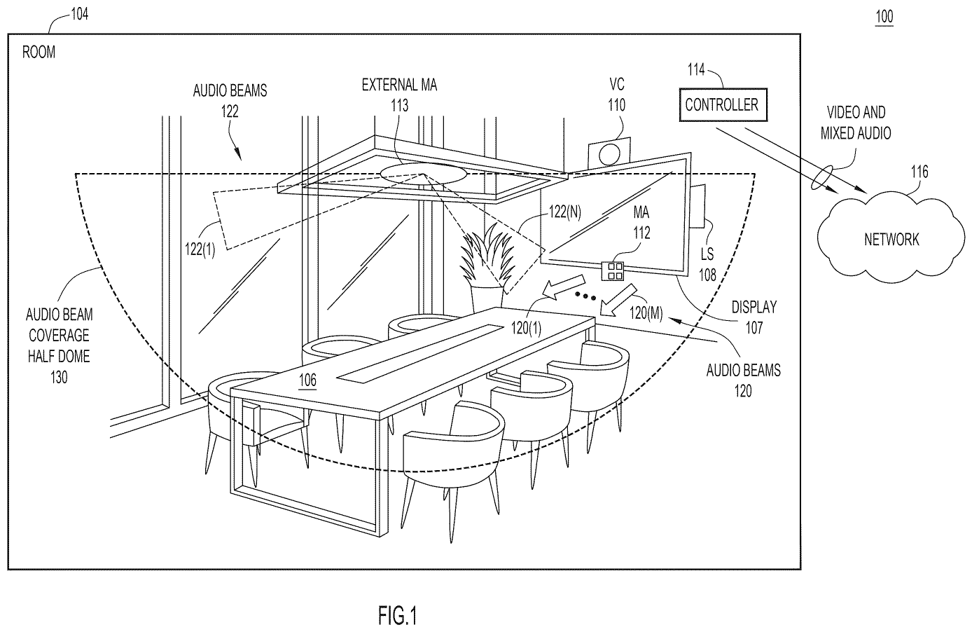

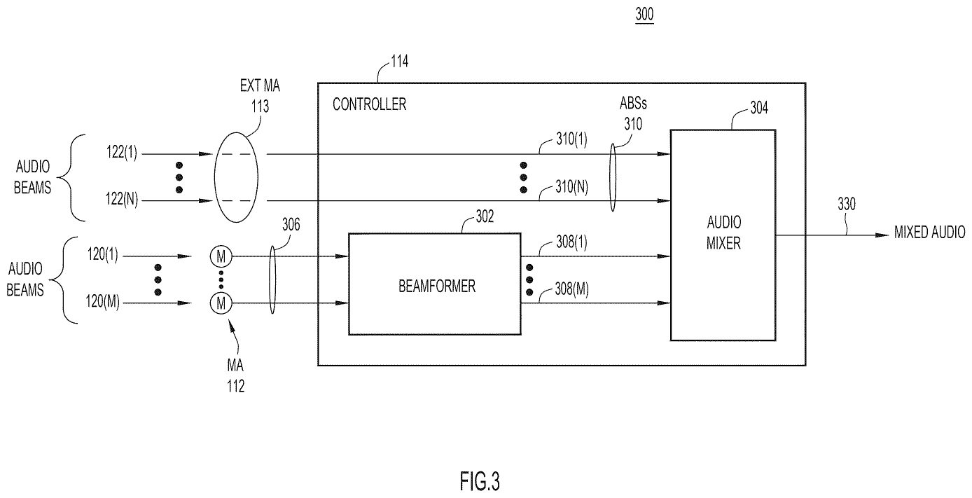

With reference to FIG. 1, there is an illustration of an example conference device 100 that mixes audio detected by audio beams formed by one or more microphone arrays based on face detection and tracking and a region-of-interest (ROI) in a meeting room, according to embodiments presented herein. In the example of FIG. 1, conference device 100 (also referred to as a “conference system” and an “endpoint device”) is deployed in a room 104 (more generally, any physical space) that includes a table 106 centered in the room and surrounded by chairs for seating participants during a video conference session (also referred to as an “online meeting” or a “video meeting”). Conference device 100 includes components that are physically distributed around room 104. FIG. 3 described below shows connections between the components.

Conference device 100 includes a video display 107, a loudspeaker (LS) 108, a video camera (VC) 110, a microphone array (MA) 112, an external (EXT) MA 113, and a controller 114 that communicates with and controls the foregoing components of the conference device. Controller 114 also communicates (e.g., exchanges data packets) with a network 116 using any known or hereafter developed communication protocols, such as, a Transmission Control Protocol (TCP)/Internet Protocol (IP) (TCP/IP), for example. Video display 107, loudspeaker 108, and MA 112 may be fixed together in a housing or an assembly that is adjacent to a back-end wall of room 104. On the other hand, EXT MA 113 may be configured to be centrally mounted in a ceiling of room 104 above table 106 and spaced-apart from VC 110, e.g., by over several feet. Moreover, EXT MA is movable relative to video display 107.

VC 110 captures video in a field-of-view (FOV) of room 104 that encompasses table 106 and the chairs surrounding the table. VC 110 provides the video to controller 114. MA 112 forms audio beams 120(1)-120(M) (collectively referred to as audio beams 120) that radiate outwardly from the MA into room 104 to detect audio in the room. Audio detected by audio beams 120 is provided to controller 114. EXT MA 113 forms audio beams 122(1)-122(N) (collectively referred to as “audio beams 122”), which radiate outwardly from the EXT MA into room 104, to detect audio in the room. Audio detected by audio beams 122 is provided to controller 114. Audio beams 122 may be elevation beams arranged radially (i.e., separated from each other in azimuth) around a central axis of EXT MA 113. For example, audio beams 122 may represent a predetermined set of fixed audio beams that cover room 104 in 360° azimuth, and 90° elevation, to create a half dome 130 of audio beam coverage. Each aforementioned “audio beam” is a receive audio beam that detects audio in room 104 and provides the detected audio to controller 114.

Conference device 100 establishes a video conference session with a remote conference device (not shown) and exchanges multimedia (e.g., audio, video, and data) with the remote conference device during the video conference session. Conference device 100 implements embodiments presented herein during the video conference session. To support the embodiments, conference device 100 may be configured with predetermined information to include known positions (e.g., location coordinates) in room 104 for VC 110 and EXT MA 113. The predetermined information also includes known coverage areas of each of audio beams 120 and 122 in room 104. Thus, the predetermined information establishes known positions (and directions) of VC 110, EXT MA 113, and the beam coverage areas relative to each other. The predetermined information may be configured on conference device 100 during a configuration operation. A user may enter the predetermined information into conference device 100. Additionally and/or alternatively, the configuration operation may execute calibration routines that establish/determine the positions of the components and coverage areas of the beams.

At a high level, conference device 100 captures video of participants in room 104, processes the video to detect faces of the participants, and determine their face positions in the room. Audio beams 120 and 122 detect audio from the participants. Conference device 100 correlates the face positions with the known coverage areas of the audio beams, to produce correlation results. The correlation results indicate audio beams that overlap face positions, and audio beams that do not overlap face positions. Conference device 100 only mixes audio detected by the audio beams that overlap with the face positions into mixed audio, and transmits the mixed audio to a remote conference device during a conference session. Conference device 100 does not mix audio from the audio beams that do not overlap the face positions.

The embodiments may also employ a predefined “meeting zone” or “region of interest” (ROI) of room 104 to further qualify which audio is to be transmitted to the remote conference device. The ROI may be a geometrical area that represents only a subset of a total area of room 104. The ROI may be pre-defined without reference to (i.e., independent of) the video and audio captured during the conference session. The ROI may include coordinates that define a boundary around the ROI. To further qualify the correlation results, conference device 100 determines which face positions are inside the ROI (referred to as “inside” face positions), and which face positions are outside the ROI (referred to as “outside” face positions). Then, conference device 100 only mixes, into the mixed audio, audio from audio beams that overlap the inside face positions. Conference device 100 does not mix, into the mixed audio, audio from audio beams that overlap only outside face positions. As long as an audio beam overlaps one or more inside face positions, the audio detected by the audio beam will be included in the mixed audio, even when the audio beam also overlaps one or more outside face positions.

As used herein, an “activated” audio beam refers to an audio beam that detects audio to be/which is included in the mixed audio, whereas a “deactivated” audio beam refers to an audio beam that detects audio which is not included in the mixed audio. Moreover, “activating” an audio beam means including audio detected by the audio beam into the mixed audio, whereas “deactivating” an audio beam means not including audio detected by the audio beam into the mixed audio.

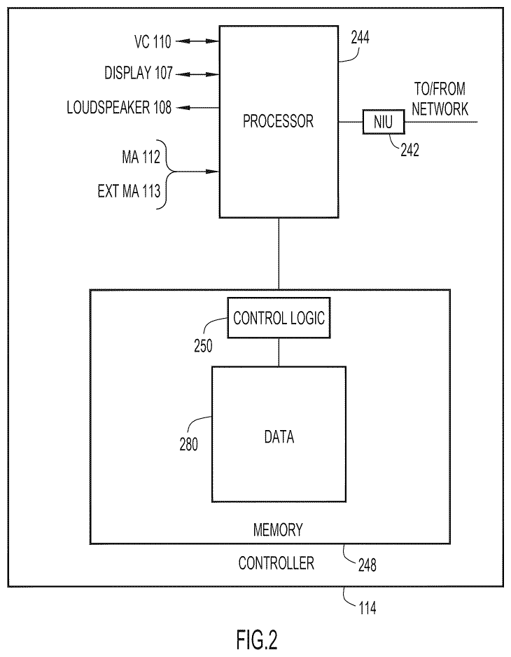

FIG. 2 is a block diagram of controller 114 according to an embodiment. There are numerous possible configurations for controller 114 and FIG. 2 is meant to be an example. Controller 114 includes a network interface (I/F) unit (NIU) 242, a processor 244, and memory 248. The aforementioned components of controller 114 may be implemented in hardware, software, firmware, and/or a combination thereof. NIU 242 is, for example, an Ethernet card or other interface device that allows the controller 114 to communicate over network 116. NIU 242 may include wired and/or wireless connection capability.

Processor 244 may include a collection of microcontrollers and/or microprocessors, for example, each configured to execute respective software instructions stored in the memory 248. The collection of microcontrollers may include, for example: a video controller to receive, send, and process video signals related to video display 107 and VC 110; an audio processor to receive, send, and process audio signals related to loudspeaker 108, MA 112, and EXT MA 113; and a high-level controller to provide overall control. Portions of memory 248 (and the instructions therein) may be integrated with processor 244. In the transmit direction, processor 244 processes audio/video of participants captured by MA 112 and EXT MA 113/VC 110, encodes the captured audio/video into data packets using audio/video codecs, and causes the encoded data packets to be transmitted to network 116. In the receive direction, processor 244 decodes audio/video from data packets received from network 116 and causes the audio/video to be presented to participants via loudspeaker 108/video display 107. As used herein, the terms “audio” and “sound” are synonymous and used interchangeably. Also, “voice” and “speech” are synonymous and used interchangeably.

The memory 248 may comprise read only memory (ROM), random access memory (RAM), magnetic disk storage media devices, optical storage media devices, flash memory devices, electrical, optical, or other physical/tangible (e.g., non-transitory) memory storage devices. Thus, in general, the memory 248 may comprise one or more computer readable storage media (e.g., a memory device) encoded with software comprising computer executable instructions and when the software is executed (by the processor 244) it is operable to perform the operations described herein. For example, the memory 248 stores or is encoded with instructions for control logic 250 perform operations described herein.

Control logic 250 includes logic to process the audio and logic to process the video. In addition, memory 248 stores data 280 used and generated by control logic 250.

FIG. 3 shows example audio signal flow 300 from MA 112 and EXT MA 113 to controller 114. In the example, controller 114 includes a beamformer 302 and an audio mixer 304. MA 112 includes microphones (Ms) that concurrently detect audio energy to produce parallel (i.e., concurrent) microphone signals 306 each from a corresponding one of the microphones. Beamformer 302 performs audio beam processing on microphone signals 306 to form audio beams 120(1)-120(M), and converts the audio energy detected by each audio beam to corresponding ones of audio beam signals (ABSs) 308(1)-308(M). For example, audio beam signal 308(1) conveys the particular audio energy (i.e., the beam-specific audio) detected by audio beam 120(1), audio beam signal 308(2) conveys the beam-specific audio detected by audio beam 120(2), and so on. Beamformer 302 maintains a mapping of audio beams 120(1)-120(M) to corresponding ones of audio beam signals 308(1)-308(M) (i.e., the beam-specific audio) produced by the audio beams.

EXT MA 113 forms audio beams 122(1)-122(N) that detect audio and convert the detected audio to corresponding ones of audio beam signals 310(1)-310(N) (collectively referred to as audio beam signals 310). Audio beam signals 310(1)-310(N) are also referred to as “beam-specific” audio beam signals. EXT MA 113 provides audio beam signals 310 to controller 114. Controller 114 maintains a mapping of audio beams signals 310(1)-310(N) to audio beams 122(1)-122(N). In an example, EXT MA 113 may turn on or turn off selected ones of audio beams 122(1)-122(N) responsive to commands supplied to the EXT MA by controller 114.

Audio mixer 304 mixes or combines into mixed audio 330 (i) selected ones of audio beam signals 308(1)-308(M) (i.e., audio detected by selected ones of audio beams 120(1)-120(M)), and (ii) selected ones of audio beam signals 310(1)-310(N) (i.e., audio detected by selected ones of audio beams 122(1)-122(N)). Audio mixer 304 transmits mixed audio 330 to network 116 during a video conference session.

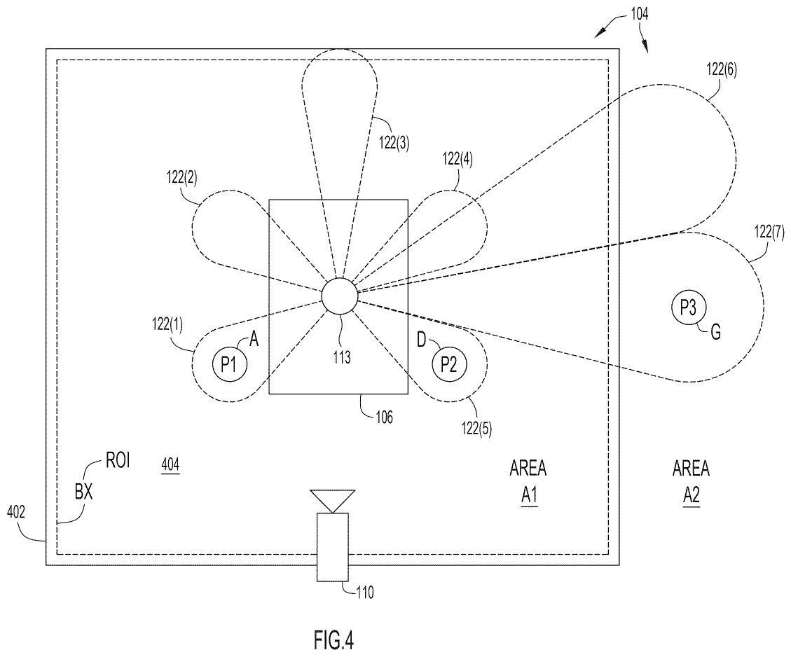

Various embodiments are now described in the context of mixing audio beams 122 from EXT MA 113 by way of example, only. It is understood that the embodiments apply equally to mixing audio beams 120 from MA 112. FIG. 4 shows a top view of an example conference arrangement of room 104 that is useful for describing operations performed by conference device 100. Room 104 includes an area A1 (also referred to as a “meeting room” or a “meeting zone”) enclosed by a wall 402 made of glass, and an area A2 that is outside of area A1. That is, wall 402 separates areas A1 and A2. Room 104 includes participants P1 and P2 seated around table 106 inside area A1, and a participant P3 located in area A2, i.e., outside of area A1. Conference device 100 is pre-configured with (i.e., stores in memory) information that pre-defines a perimeter or boundary box BX around an ROI 404 such that the ROI is coextensive with only area A1.

The information may define points (also referred to as “boundary points”) along boundary box BX. Each point may be defined by a coordinate tuple, such as a two-dimensional (2D) and/or a three-dimensional (3D) coordinate tuple. In an example, the coordinate tuples may include angles spanning an angle range (e.g., 0 to 180°) measured from a plane of VC 110 (or alternatively from a normal to the VC looking in the room) and distances from the VC for corresponding ones of the angles. Table 1 below shows an example of the coordinate tuples in tabular form.

TABLE 1

| Angle From | Distance |
|---|---|
| Plane of VC | from VC |
| θ1 | D1 |
| θ2 | D2 |
| θ3 | D3 |
| θ4 | D4 |

In practice, Table 1 includes many more (angle, distance) coordinate tuples to define more points along boundary box BX. In another example, the points may be defined as rectangular coordinates of the room.

During a video conference session, VC 110 captures video of areas A1 and A2, and provides the video to controller 114. Controller 114 performs face detection and tracking on the video to detect (i) faces of participants P1 and P2 and their corresponding/respective face positions A and D in area A1, and (ii) a face of participant P3 and a corresponding face position G in area A2. Each face position may be defined as an (angle, distance) coordinate tuple similar to those in Table 1, or may defined in (cartesian or rectangular) 3D coordinates, for example. Controller 114 may employ any known of hereafter developed face detection and tracking technique to detect and track the faces. As used herein, “face detection and tracking” may sometimes be referred to as “head detection and tracking.”

Controller 114 compares each face position A, D, and G to ROI 404 (e.g., boundary box BX) to produce compare results that indicate whether each face position is an “inside” face position that is inside ROI 404, or an “outside” face position that is outside the ROI. In the example, the compare results indicate that face positions A and D are both inside face positions, and face position G is an outside face position.

During the video conference session, EXT MA 113 forms audio beams 122(1)-122(7) having beam coverage areas (shown in dashed lines) that are spread across areas A1 and A2. Each coverage area has a pointing direction (i.e., angle) from the axis of EXT MA 113 and a beamwidth (i.e., an angle range about the pointing direction). Controller 114 determines which of audio beams 122(1)-122(7) overlaps at least one of inside face positions A and D. For example, controller 114 compares the respective beam coverage areas of audio beams 122(1)-122(7) to inside face positions A and D to produce compare results, which may be based on straightforward triangle geometry. The compare results indicate that the beam coverage areas of audio beams 122(1) and 122(5) overlap face positions A and D. Therefore, controller 114 designates audio beams 122(1) and 122(5) as activated audio beams. Controller 114 designates all other audio beams (i.e., audio beams 122(2)-122(4), 122(6), and 122(7)), as deactivated audio beams.

Controller 114 mixes into mixed audio 330 only the beam-specific audio detected by audio beams 122(1) and 122(5) that are activated. Controller 114 does not include in mixed audio 330 the beam-specific audio from the deactivated audio beams. That is, controller 114 excludes the beam-specific audio from the deactivated audio beams from mixed audio 330. Controller 114 transmits mixed audio 330 to network 116.

Controller 114 may employ artificial intelligence (AI) and machine learning (ML), and other video processing techniques, to implement the operations described herein. For example, controller 114 may employ known computer vision to detect face positions relative to VC 110. The AI/ML and video processing techniques can also be used to determine whether a face should not be considered part of the video conference session. Such a face may include a face that is detected on an opposite side of a glass wall as described above, or that is presented on an object, such as a photograph, a display screen, a wall, and so on. Moreover, the AI/ML and video processing techniques may be trained to filter-out glare from glass, which would otherwise impair face detection.

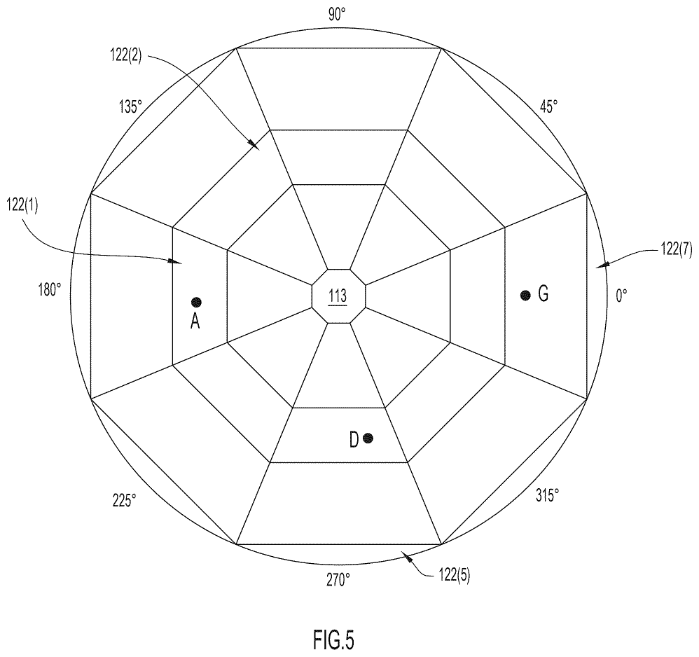

FIG. 5 shows a two-dimensional (2D) projection of the area covered by audio beams 122 arranged around azimuthal directions 0, 45, 90, 135, 180, 225, 270, and 315 degrees. Each trapezoid represent a portion of a coverage area of one of the beams. Face positions A, D, and G for participants P1, P2, and P3 are shown within the coverage areas of audio beams 122(1), 122(5), and 122(7).

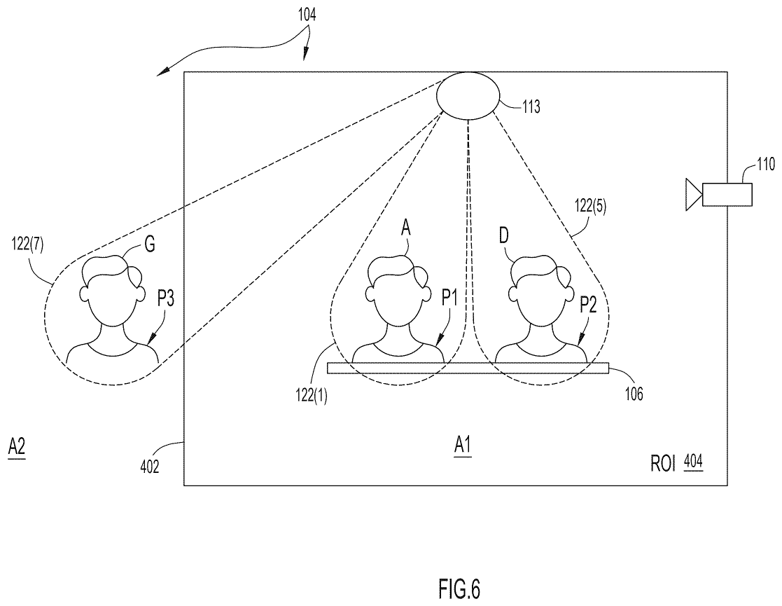

FIG. 6 shows a side view of the conference arrangement of room 104 corresponding to the top view of FIG. 4. Controller 114 detects the face of participant P3 having face position G outside of area A1 and boundary box BX because wall 402 is made of glass. Although audio beam 122(7) overlaps with face position G, controller 114 designates that audio beam as deactivated because face position G is an outside face position. Therefore, controller 114 does not mix beam-specific audio for audio beam 122(7) into mixed audio 330, which helps prevent reverberation. In an arrangement in which wall 402 is omitted (i.e., in which there is no physical barrier between areas A1 and A2), beam-specific audio for audio beam 122(7) would still not be included in mixed audio 330 because face position G remains outside of ROI 404.

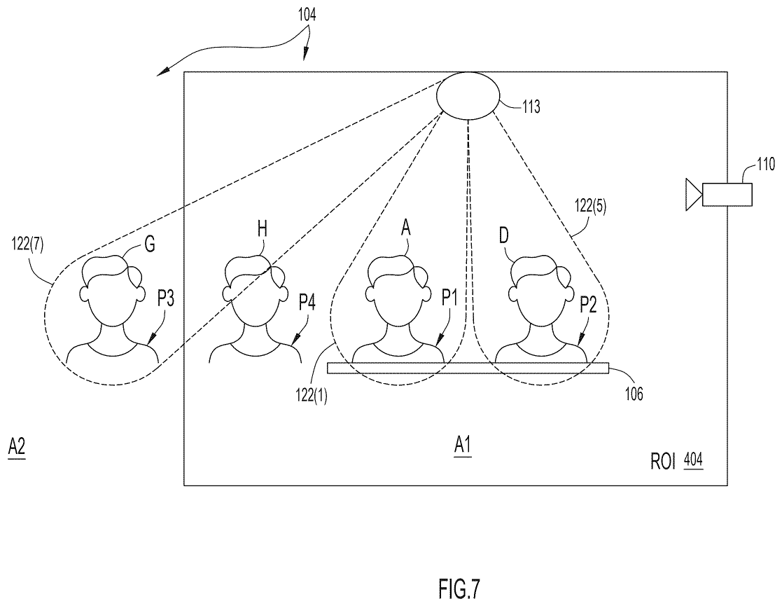

FIG. 7 shows a side view of another conference arrangement of room 104 for which controller 114 detects a face of an additional participant P4 having a face position H that overlaps audio beam 122(7) in addition to face G. In contrast to face position G, face position H is inside ROI 404 (and thus qualifies as an inside face position). In this arrangement, controller 114 re-designates audio beam 122(7) as an activated audio beam (i.e., controller 114 activates the previously deactivated audio beam), and additionally mixes beam-specific audio detected by that activated audio beam into mixed audio 330. More generally, controller 114 designates an audio beam as an activated audio beam provided that the audio beam overlaps one or more inside face positions, even when the audio beam also overlaps an outside face position. In another conference arrangement in which controller 114 detects a face with an inside face position that is close to a border between two audio beams, controller 114 designates/treats both audio beams as activated audio beams.

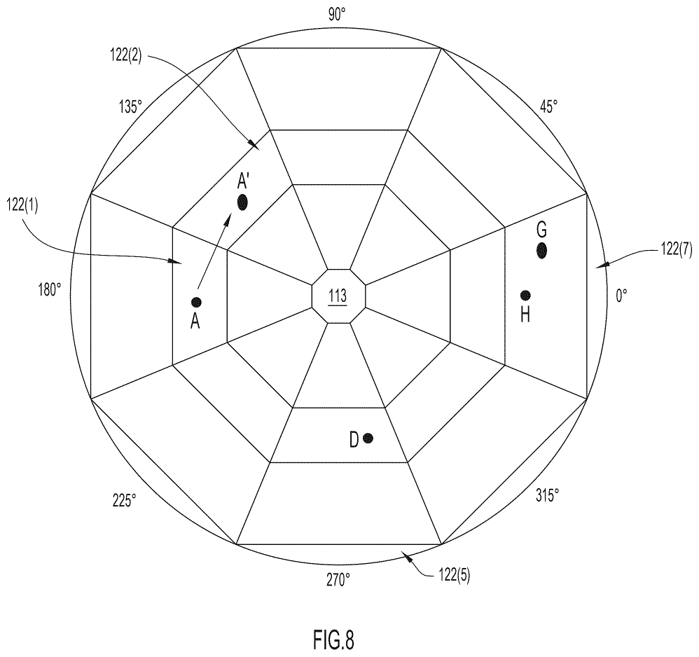

FIG. 8 shows another conference arrangement in which controller 114 performs face tracking to track the movement of face positions over time. For example, controller 114 tracks the faces and repeatedly updates their corresponding face positions at regular intervals. In response to the face tracking, controller 114 activates and deactivates the audio beams to reflect changes in the face positions, e.g., as the face positions cross different audio beams and/or move into and out of ROI 404. In the example, the face at face position A in audio beam 122(1) that is activated (and that is also in ROI 404) begins moving towards audio beam 122(2) that is deactivated. Upon determining that the face is about to cross into audio beam 122(2) (and is to remain in ROI 404) based on the tracking, controller 114 activates audio beam 122(2) (which transitions from a deactivated audio beam to a newly activated audio beam), and starts mixing, into the mixed audio, beam-specific audio detected by the newly activated audio beam.

When the face has moved from audio beam 122(1) which is activated to a new face position A′ in audio beam 122(2) which is newly activated, controller 114 continues to maintain audio beam 122(1) in the activated state only for a predetermined time period (during which both audio beams 122(2) and 122(1) are activated). When the predetermined time period expires, controller 114 deactivates audio beam 122(1), which becomes deactivated.

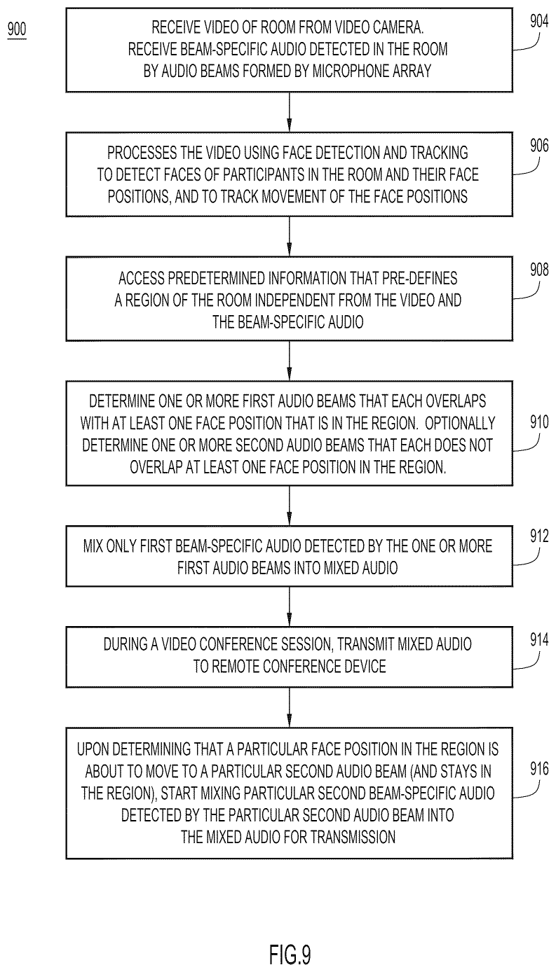

FIG. 9 is a flowchart of an example method 900 of mixing audio beams from a microphone array based on head detection and tracking and an ROI, performed by a conference device (e.g., conference device 100) deployed in a room. Method 900 may be performed while the conference device participates in a video conference session with a remote conference device over a network. The conference device includes a video camera, a microphone array, and a controller coupled to the video camera and the microphone array. The video camera captures video of the room and provides the video to the controller. The microphone array forms audio beams spread across the room and that detect beam-specific audio, and provide the beam-specific audio to the controller. The video camera and the microphone array have known positions relative to each other in the room, and the audio beams have known beam coverage areas.

At 904, the controller receives the video of the room from the video camera. The controller also receives the beam-specific audio of the room detected by the audio beams formed by the microphone array.

At 906, the controller processes the video using face detection and tracking techniques to detect faces of participants in the room and their face positions, and to track movement of the face positions.

At 908, the controller accesses predetermined information that pre-defines an ROI (also referred to simply as a “region”) in the room independent from the video and the beam-specific audio. The region may encompasses an area that is smaller than a full area of the room.

At 910, the controller positionally compares the coverage area of each audio beam to each face position and to the region to produce compare results. In an example, the controller performs the aforementioned compare operation without using/processing any beam-specific audio. Based on the compare results, the controller determines one or more first audio beams (referred to above as activated audio beams) that overlap with at least one face position that is in the region (i.e., an inside face position). In an example, the one or more first audio beams represent less than all of the audio beams. The controller may also determine one or more second audio beams (also referred to as deactivated audio beams) each of which does not overlap at least one face position in the region. For example, a particular second audio beam may overlap only a face position that is outside the region. In the example, the one or more second audio beams represent less than all of the audio beams and do not include any of the one or more first audio beams.

At 912, the controller mixes first beam-specific audio detected by the one or more first audio beams into mixed audio. That is, the controller mixes first beam-specific audio detected by respective ones of the one or more first audio beams into the mixed audio. The controller does not mix second beam-specific audio detected by the one or more second audio beams into the mixed audio. That is, the controller mixes into the mixed audio only the first beam-specific audio, and not the second beam-specific audio.

During the video conference session, at 914, the controller transmits the mixed audio to the remote conference device.

Upon determining that a particular face position in the region is about to move to a position that overlaps with a particular second audio beam (i.e., one of the second audio beams that does not overlap any face position) and the region, at 916, the controller starts mixing particular second beam-specific audio detected by the particular second audio beam into the mixed audio for transmission, and starts transmitting the particular second beam-specific audio with the mixed audio. Upon determining that the particular face position moved from a first position that overlaps with a particular first audio beam to a second position in the region that overlaps with the second audio beam (but does not overlap with the particular first audio beam), the controller continues transmitting particular first beam-specific audio detected by the particular first audio beam only for a predetermined time period.

It is understood that in some embodiments, controller 114 may perform the operations described to classify audio beams that overlap at least one face position based solely on which audio beams overlap which face positions, without using an ROI as a qualifier.

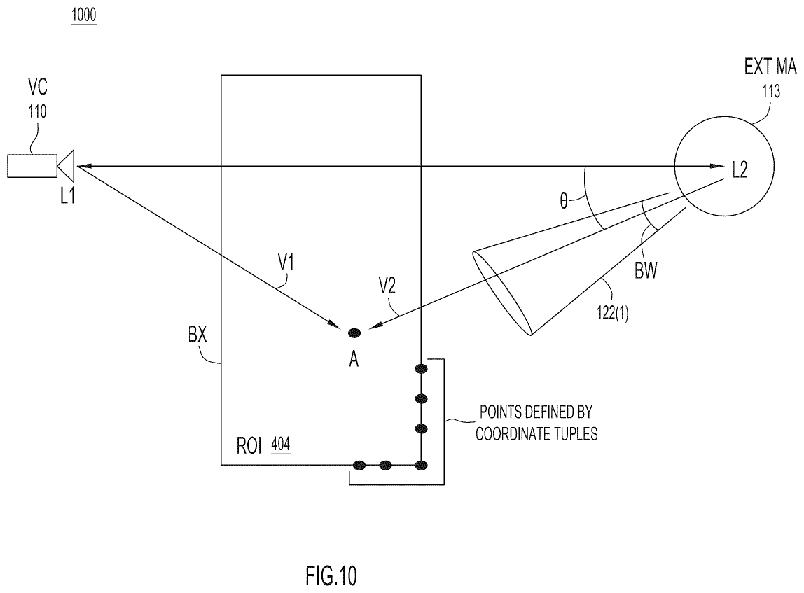

FIG. 10 shows example geometry 1000 that may be used to determine whether face position A is in audio beam 122(1) and inside ROI 404 (i.e., in boundary box BX). Geometry 1000 is based on the example conference arrangement of FIG. 4. VC 110, EXT MA 113, and the face of participant P1 have known positions L1, L2, and A. Audio beam 122(1) has a known pointing direction θ and beamwidth BW. Based on the known positions, vectors V1 and V2 may be drawn from L1 to A and from L2 to A, as shown. Each vector has both direction (angle) and length (or distance). Face position A can be determined to fall within audio beam 122(1) given the direction of vector V2, the pointing direction θ of the audio beam, and beamwidth BW. Moreover, face position A can be determined to fall within ROI 404 (i.e., inside boundary box BX) given the face position relative to the points of boundary box BX that are defined by coordinate tuples, only some of which are shown in FIG. 10; e.g., by comparing the face position to the points.

In summary, embodiments presented herein employ face detection and tracking to detect faces of participants in a room during a meeting conference, and map the faces against a pre-defined ROI or meeting zone. The embodiments use the map to only select audio beams formed by a microphone array (e.g., a ceiling-mounted microphone array) that cover the participants, and transmit to a remote end audio detected by the selected audio beams, only. The audio received at the remote end is less reverberant and less confusing because audio from individuals outside the ROI is not transmitted to the remote end.

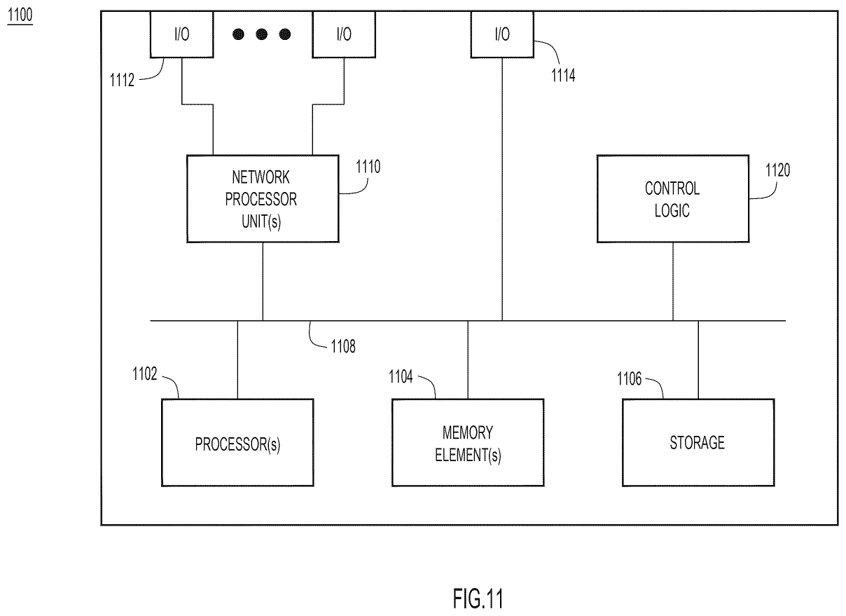

Referring to FIG. 11, FIG. 11 illustrates a hardware block diagram of a computing device 1100 that may perform functions associated with operations discussed herein in connection with the techniques depicted in FIGS. 1-10. In various embodiments, a computing device or apparatus, such as computing device 1100 or any combination of computing devices 1100, may be configured as any entity/entities as discussed for the techniques depicted in connection with FIGS. 1-10 in order to perform operations of the various techniques discussed herein. For example, computing device 1100 may represent conference device 100 and controller 114.

In at least one embodiment, the computing device 1100 may be any apparatus that may include one or more processor(s) 1102, one or more memory element(s) 1104, storage 1106, a bus 1108, one or more network processor unit(s) 1110 interconnected with (e.g., coupled to) one or more network input/output (I/O) interface(s) 1112, one or more I/O interface(s) 1114, and control logic 1120. In various embodiments, instructions associated with logic for computing device 1100 can overlap in any manner and are not limited to the specific allocation of instructions and/or operations described herein.

In at least one embodiment, processor(s) 1102 is/are at least one hardware processor configured to execute various tasks, operations and/or functions for computing device 1100 as described herein according to software and/or instructions configured for computing device 1100. Processor(s) 1102 (e.g., a hardware processor) can execute any type of instructions associated with data to achieve the operations detailed herein. In one example, processor(s) 1102 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 1104 and/or storage 1106 is/are configured to store data, information, software, and/or instructions associated with computing device 1100, and/or logic configured for memory element(s) 1104 and/or storage 1106. For example, any logic described herein (e.g., control logic 1120) can, in various embodiments, be stored for computing device 1100 using any combination of memory element(s) 1104 and/or storage 1106. Note that in some embodiments, storage 1106 can be consolidated with memory element(s) 1104 (or vice versa), or can overlap/exist in any other suitable manner.

In at least one embodiment, bus 1108 can be configured as an interface that enables one or more elements of computing device 1100 to communicate in order to exchange information and/or data. Bus 1108 can be implemented with any architecture designed for passing control, data and/or information between processors, memory elements/storage, peripheral devices, and/or any other hardware and/or software components that may be configured for computing device 1100. In at least one embodiment, bus 1108 may be implemented as a fast kernel-hosted interconnect, potentially using shared memory between processes (e.g., logic), which can enable efficient communication paths between the processes.

In various embodiments, network processor unit(s) 1110 may enable communication between computing device 1100 and other systems, entities, etc., via network I/O interface(s) 1112 (wired and/or wireless) to facilitate operations discussed for various embodiments described herein. In various embodiments, network processor unit(s) 1110 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 1100 and other systems, entities, etc. to facilitate operations for various embodiments described herein. In various embodiments, network I/O interface(s) 1112 can be configured as one or more Ethernet port(s), Fibre Channel ports, any other I/O port(s), and/or antenna(s)/antenna array(s) now known or hereafter developed. Thus, the network processor unit(s) 1110 and/or network I/O interface(s) 1112 may include suitable interfaces for receiving, transmitting, and/or otherwise communicating data and/or information in a network environment.

I/O interface(s) 1114 allow for input and output of data and/or information with other entities that may be connected to computing device 1100. For example, I/O interface(s) 1114 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, control logic 1120 can include instructions that, when executed, cause processor(s) 1102 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 1120) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, any entity or apparatus as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 1104 and/or storage 1106 can store data, software, code, instructions (e.g., processor instructions), logic, parameters, combinations thereof, and/or the like used for operations described herein. This includes memory element(s) 1104 and/or storage 1106 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

In various example implementations, any entity or apparatus for various embodiments described herein can encompass network elements (which can include virtualized network elements, functions, etc.) such as, for example, network appliances, forwarders, routers, servers, switches, gateways, bridges, loadbalancers, firewalls, processors, modules, radio receivers/transmitters, or any other suitable device, component, element, or object operable to exchange information that facilitates or otherwise helps to facilitate various operations in a network environment as described for various embodiments herein. Note that with the examples provided herein, interaction may be described in terms of one, two, three, or four entities. However, this has been done for purposes of clarity, simplicity and example only. The examples provided should not limit the scope or inhibit the broad teachings of systems, networks, etc. described herein as potentially applied to a myriad of other architectures.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of can be represented using the’ (s)′ nomenclature (e.g., one or more element(s)).

In some aspects, the techniques described herein relate to a method performed by a controller of a conference device that includes a video camera and a microphone array deployed in a room, the method including: receiving video of the room from the video camera; receiving beam-specific audio of the room detected by respective ones of audio beams formed by the microphone array; processing the video to detect face positions of faces in the room; accessing information that pre-defines a region in the room independent from the video and the beam-specific audio; determining one or more first audio beams that each overlaps any face position in the region; and during a video conference session, transmitting, to a remote conference device, first beam-specific audio detected by the one or more first audio beams.

In some aspects, the techniques described herein relate to a method, further including: determining one or more second audio beams of the audio beams that each does not overlap any face position in the region; and not transmitting, to the remote conference device, second beam-specific audio detected by the one or more second audio beams.

In some aspects, the techniques described herein relate to a method, further including: tracking movement of a particular face position; and upon determining that the particular face position is about to move to a position that overlaps with a particular second audio beam of the one or more second audio beams and that is in the region, starting transmitting particular second beam-specific audio detected by the particular second audio beam.

In some aspects, the techniques described herein relate to a method, further including: tracking movement of a particular face position; and upon determining that the particular face position has moved from a first position in the region that overlaps a particular first audio beam to a second position in the region that overlaps a particular second audio beam, but does not overlap the particular first audio beam, continuing transmitting particular first beam-specific audio detected by the particular first audio beam only for a predetermined time period.

In some aspects, the techniques described herein relate to a method, wherein: the one or more first audio beams includes a particular first audio beam that overlaps a first face position in the region and a second face position that is not in the region.

In some aspects, the techniques described herein relate to a method, further including: determining the one or more first audio beams includes positionally comparing a known coverage area of each audio beam to each face position and to the region.

In some aspects, the techniques described herein relate to a method, wherein: the information includes coordinate tuples that define boundary points around the region.

In some aspects, the techniques described herein relate to a method, wherein: the coordinate tuples include angles across an angle range looking from the video camera into the room and distances for corresponding ones of the angles.

In some aspects, the techniques described herein relate to a method wherein: the coordinate tuples include rectangular coordinates of the room that define the boundary points.

In some aspects, the techniques described herein relate to a method, wherein: the microphone array is mounted in or adjacent to a ceiling of the room and is spaced-apart from the video camera, and is configured to form the audio beams as elevation beams that are arranged around an axis of the microphone array.

In some aspects, the techniques described herein relate to an apparatus including: a video camera to capture video of a room; a microphone array to form audio beams across the room and which detect beam-specific audio in the room; a network interface unit to communicate with a network; and a controller coupled to the video camera, the microphone array, and the network interface unit, wherein the controller is configured to perform: processing the video to detect face positions of faces in the room; accessing information that pre-defines a region in the room independent from the video and the beam-specific audio; determining one or more first audio beams of the audio beams that each overlaps any face position that is in the region; and during a video conference session, transmitting, to a remote conference device, the beam-specific audio detected by the one or more first audio beams.

In some aspects, the techniques described herein relate to an apparatus, wherein the controller is further configured to perform: determining one or more second audio beams of the audio beams that each does not overlap any face position in the region; and not transmitting, to the remote conference device, second beam-specific audio detected by the one or more second audio beams.

In some aspects, the techniques described herein relate to an apparatus, wherein the controller is configured to perform: tracking movement of a particular face position; and upon determining that the particular face position is about to move to a position that overlaps with a particular second audio beam of the one or more second audio beams and that is in the region, starting transmitting particular second beam-specific audio detected by the particular second audio beam.

In some aspects, the techniques described herein relate to an apparatus, wherein the controller is configured to perform: tracking movement of a particular face position; and upon determining that the particular face position has moved from a first position in the region that overlaps a particular first audio beam to a second position in the region that overlaps a particular second audio beam, but does not overlap the particular first audio beam, continuing transmitting particular first beam-specific audio detected by the particular first audio beam only for a predetermined time period.

In some aspects, the techniques described herein relate to an apparatus, wherein: the one or more first audio beams includes a particular first audio beam that overlaps a first face position in the region and a second face position that is not in the region.

In some aspects, the techniques described herein relate to an apparatus, wherein the controller is configured to perform: determining the one or more first audio beams includes positionally comparing a known coverage area of each audio beam to each face position and to the region.

In some aspects, the techniques described herein relate to an apparatus, wherein: the information includes coordinate tuples that define boundary points around the region.

In some aspects, the techniques described herein relate to a non-transitory computer readable medium encoded with instructions that, when executed by a controller of a conference device that includes a video camera and a microphone array, causes the controller to perform: receiving video of a room from the video camera; receiving beam-specific audio of the room detected by audio beams formed by the microphone array; processing the video to detect face positions of faces in the room; accessing information that pre-defines a region in the room independent from the video and the beam-specific audio; determining one or more first audio beams of the audio beams that each overlaps any face position that is in the region; and during a video conference session, transmitting, to a remote conference device, first beam-specific audio detected by the one or more first audio beams.

In some aspects, the techniques described herein relate to a non-transitory computer readable medium, further including instructions to cause the controller to perform: determining one or more second audio beams of the audio beams that each does not overlap any face position in the region; and not transmitting, to the remote conference device, second beam-specific audio detected by the one or more second audio beams.

In some aspects, the techniques described herein relate to a non-transitory computer readable medium, further including instructions to cause the controller to perform: tracking movement of a particular face position; and upon determining that the particular face position is about to move to a position that overlaps with a particular second audio beam of the one or more second audio beams and that is in the region, starting transmitting particular second beam-specific audio detected by the particular second audio beam.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method performed by a controller of a conference device that includes a video camera and a microphone array deployed in a room, the method comprising:
receiving video of the room from the video camera;
receiving beam-specific audio of the room detected by respective ones of audio beams formed by the microphone array;
processing the video to detect face positions of faces in the room;
accessing information that pre-defines a region in the room independent from the video and the beam-specific audio;
determining one or more first audio beams that each overlaps any face position in the region; and
during a video conference session, transmitting, to a remote conference device, first beam-specific audio detected by the one or more first audio beams.

2. The method of claim 1, further comprising:
determining one or more second audio beams of the audio beams that each does not overlap any face position in the region; and
not transmitting, to the remote conference device, second beam-specific audio detected by the one or more second audio beams.

3. The method of claim 2, further comprising:
tracking movement of a particular face position; and
upon determining that the particular face position is about to move to a position that overlaps with a particular second audio beam of the one or more second audio beams and that is in the region, starting transmitting particular second beam-specific audio detected by the particular second audio beam.

4. The method of claim 2, further comprising:
tracking movement of a particular face position; and
upon determining that the particular face position has moved from a first position in the region that overlaps a particular first audio beam to a second position in the region that overlaps a particular second audio beam, but does not overlap the particular first audio beam, continuing transmitting particular first beam-specific audio detected by the particular first audio beam only for a predetermined time period.

5. The method of claim 1, wherein:
the one or more first audio beams includes a particular first audio beam that overlaps a first face position in the region and a second face position that is not in the region.

6. The method of claim 1, further comprising:
determining the one or more first audio beams includes positionally comparing a known coverage area of each audio beam to each face position and to the region.

7. The method of claim 1, wherein:
the information includes coordinate tuples that define boundary points around the region.

8. The method of claim 7, wherein:
the coordinate tuples include angles across an angle range looking from the video camera into the room and distances for corresponding ones of the angles.

9. The method of claim 7 wherein:
the coordinate tuples include rectangular coordinates of the room that define the boundary points.

10. The method of claim 1, wherein:
the microphone array is mounted in or adjacent to a ceiling of the room and is spaced-apart from the video camera, and is configured to form the audio beams as elevation beams that are arranged around an axis of the microphone array.

11. An apparatus comprising:
a video camera to capture video of a room;
a microphone array to form audio beams across the room and which detect beam-specific audio in the room;
a network interface unit to communicate with a network; and
a controller coupled to the video camera, the microphone array, and the network interface unit, wherein the controller is configured to perform:
processing the video to detect face positions of faces in the room;
accessing information that pre-defines a region in the room independent from the video and the beam-specific audio;
determining one or more first audio beams of the audio beams that each overlaps any face position that is in the region; and
during a video conference session, transmitting, to a remote conference device, the beam-specific audio detected by the one or more first audio beams.

12. The apparatus of claim 11, wherein the controller is further configured to perform:
determining one or more second audio beams of the audio beams that each does not overlap any face position in the region; and
not transmitting, to the remote conference device, second beam-specific audio detected by the one or more second audio beams.

13. The apparatus of claim 12, wherein the controller is configured to perform:
tracking movement of a particular face position; and
upon determining that the particular face position is about to move to a position that overlaps with a particular second audio beam of the one or more second audio beams and that is in the region, starting transmitting particular second beam-specific audio detected by the particular second audio beam.

14. The apparatus of claim 12, wherein the controller is configured to perform:
tracking movement of a particular face position; and
upon determining that the particular face position has moved from a first position in the region that overlaps a particular first audio beam to a second position in the region that overlaps a particular second audio beam, but does not overlap the particular first audio beam, continuing transmitting particular first beam-specific audio detected by the particular first audio beam only for a predetermined time period.

15. The apparatus of claim 11, wherein:
the one or more first audio beams includes a particular first audio beam that overlaps a first face position in the region and a second face position that is not in the region.

16. The apparatus of claim 11, wherein the controller is configured to perform:
determining the one or more first audio beams includes positionally comparing a known coverage area of each audio beam to each face position and to the region.

17. The apparatus of claim 11, wherein:
the information includes coordinate tuples that define boundary points around the region.

18. A non-transitory computer readable medium encoded with instructions that, when executed by a controller of a conference device that includes a video camera and a microphone array, causes the controller to perform:
receiving video of a room from the video camera;
receiving beam-specific audio of the room detected by audio beams formed by the microphone array;
processing the video to detect face positions of faces in the room;
accessing information that pre-defines a region in the room independent from the video and the beam-specific audio;
determining one or more first audio beams of the audio beams that each overlaps any face position that is in the region; and
during a video conference session, transmitting, to a remote conference device, first beam-specific audio detected by the one or more first audio beams.

19. The non-transitory computer readable medium of claim 18, further comprising instructions to cause the controller to perform:
determining one or more second audio beams of the audio beams that each does not overlap any face position in the region; and
not transmitting, to the remote conference device, second beam-specific audio detected by the one or more second audio beams.

20. The non-transitory computer readable medium of claim 19, further comprising instructions to cause the controller to perform:
tracking movement of a particular face position; and
upon determining that the particular face position is about to move to a position that overlaps with a particular second audio beam of the one or more second audio beams and that is in the region, starting transmitting particular second beam-specific audio detected by the particular second audio beam.
